(19) United States
(12) Patent Application Publication
(10) Pub. No.: US 2015/0179083 A1
(43) Pub. Date: Jun. 25, 2015

(54) INTERACTIVE INTERFACE FOR ASSET HEALTH MANAGEMENT

(71) Applicant: ABB Technology AG, Zurich (CH)

(72) Inventors: Karen J. Smiley, Raleigh, NC (US); Shakeel M. Mahate, Raleigh, NC (US); Paul F. Wood, Rocklin, CA (US)

(21) Appl. No.: 14/577,089

(22) Filed: Dec. 19, 2014

Related U.S. Application Data
(60) Provisional application No. 61/919,906, filed on Dec. 23, 2013.

(51) Int. Cl. G09B 9/00; G06N 5/02

(52) U.S. Cl. CPC G09B 9/00; G06N 5/02

(57) ABSTRACT

One or more techniques and/or systems are provided for providing an interactive game interface for asset management. The interactive game interface may be used to train users, such as employees of a particular industry (e.g., an electrical utility industry), and/or capture knowledge from users. A knowledge module may be associated with asset health management (e.g., real-time management of industrial assets). The knowledge module may be evaluated to generate an asset health management scenario (e.g., a scenario where a user is to take action with respect to a power outage). The asset health management scenario may be provided through the interactive game interface in order to train users. User interaction data associated with the asset health management scenario, such as a user specified action plan, may be used to update the knowledge module and/or the asset health management scenario with relatively more efficient and/or up-to-date information.

### RELATED APPLICATION

This application claims priority to U.S. Provisional Patent Application No. 61/919,906, filed on Dec. 23, 2013 and titled “INTERACTIVE GAME INTERFACE FOR ASSET HEALTH MANAGEMENT,” which is incorporated herein.

### BACKGROUND

Many industries, such as electric utilities, mining, water, etc., employ a vast number of assets for operation. In an example, an asset, such as an industrial asset, comprises infrastructure, operating equipment, tangible equipment, physical equipment, processing equipment, etc. An industry may employ an aging workforce having substantial knowledge about assets of the industry (e.g., an electric utility company may employ technicians that have considerable knowledge and experience diagnosing, repairing, replacing, and/or making other decisions regarding electrical assets, such as transformers or circuit breakers). The industry may lose asset experts and their knowledge to retirement and/or attrition. Newer employees may lack such knowledge with respect to aging legacy equipment. Thus, the industry may spend substantial amounts of resources in hiring and training new employees that manage assets.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

In an embodiment of providing an interactive game interface for asset health management, a knowledge module associated with asset health management may be identified. For example, an electrical utility knowledge module may comprise a variety of information and/or algorithms, such as health diagnosis information regarding assets (e.g., how to diagnose a transformer; how often to remotely test a circuit breaker; determining whether an asset is overloaded or is operating at a degraded state; etc.), maintenance recommendation information (e.g., repair intervals for a transmission line; replacement intervals for a circuit breaker; conditions under which a repair crew is to be sent out; conditions under which an asset is to continue operation; etc.), criticality information (e.g., economic impact of a decision to repair or continue operation of an asset; whether continued operation of an asset will damage the asset; environmental impact of a decision; whether a decision for an asset will impact other assets; costs of a decision; benefits of a decision; etc.), and/or a wide variety of other information related to assets and/or asset health management.

An asset health management scenario may be generated based upon the knowledge module. The asset health management scenario may detail information about a scenario for which a user is to provide an action plan (e.g., the user may “play” the asset health management scenario as an interactive game, such as for training purposes). For example, the asset health management scenario may display a visualization of one or more assets (e.g., a transformer with liquid leaking from the bottom), situational information about the one or more assets (e.g., a report that a burning smell was noticed near the transformer; a reported power outage; an alarm; etc.), and/or one or more action plans that may be selected by the user (e.g., send a repair crew; continue operation; schedule maintenance in a month; etc.). In this way, the asset health management scenario may be provided through an interactive game interface to users for interactive gameplay.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of providing an interactive game interface for asset health management.

FIG. 2 is a component block diagram illustrating an exemplary system for identifying one or more knowledge modules.

FIG. 3 is a component block diagram illustrating an exemplary system for providing an interactive game interface.

FIG. 4 is a component block diagram illustrating an exemplary system for presenting a diagnosis interface through an interactive game interface.

FIG. 5 is a component block diagram illustrating an exemplary system for presenting diagnosis results through a diagnosis interface provided through an interactive game interface.

FIG. 6 is a component block diagram illustrating an exemplary system for presenting an action plan interface through an interactive game interface.

FIG. 7 is a component block diagram illustrating an exemplary system for presenting a consequence through an interactive game interface.

FIG. 8 is a component block diagram illustrating an exemplary system for presenting a decision evaluation through an interactive game interface.

FIG. 9 is a component block diagram illustrating an exemplary system for modifying a knowledge module and/or interactive game interface data utilizing an update derived from user interaction data associated with an interactive game interface.

FIG. 10 is an illustration of an exemplary computing device-readable medium wherein processor-executable instructions configured to embody one or more of the provisions set forth herein may be comprised.

FIG. 11 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

As provided herein, an interactive game interface for asset health management is provided. Asset health management scenarios, corresponding to diagnostics, maintenance recommendations, and/or optimizing decision making with regards to assets, may be provided through the interactive game interface in order to train users that participate in such asset health management scenarios. Knowledge related to asset health management may be captured from users that participate in asset health management scenarios. An asset health management scenario may provide an interactive training experience where a user may interactively learn how to understand asset conditions, diagnose causes of such conditions, predict outcomes related to such conditions, and/or implement action plans for assets. The asset health management scenario may leverage information within knowledge modules associated with asset health management so that such information may be passed along to users of the interactive game interface (e.g., an asset health management scenario may involve an asset with which an employee is to be trained). User interaction data with the interactive game interface, such as action plans, may be used as feedback in order to update asset management scenarios and/or knowledge modules (e.g., a user may create an action plan that may address a scenario in a unique and/or efficient manner not already provided by information within a knowledge module). In this way, training content may be continually refreshed (e.g., asset health management scenarios may be created and/or updated based upon updates to knowledge modules derived from real-life information), training sessions may be improved (e.g., a user may become more engaged when participating in a game rather than merely listening to instructions on best practices), training effectiveness may be increased (e.g., a user may be provided with dynamic and diverse scenarios that may otherwise require years of shadowing an expert), training content may be dynamically updated based upon how users solve asset health management scenarios, etc.

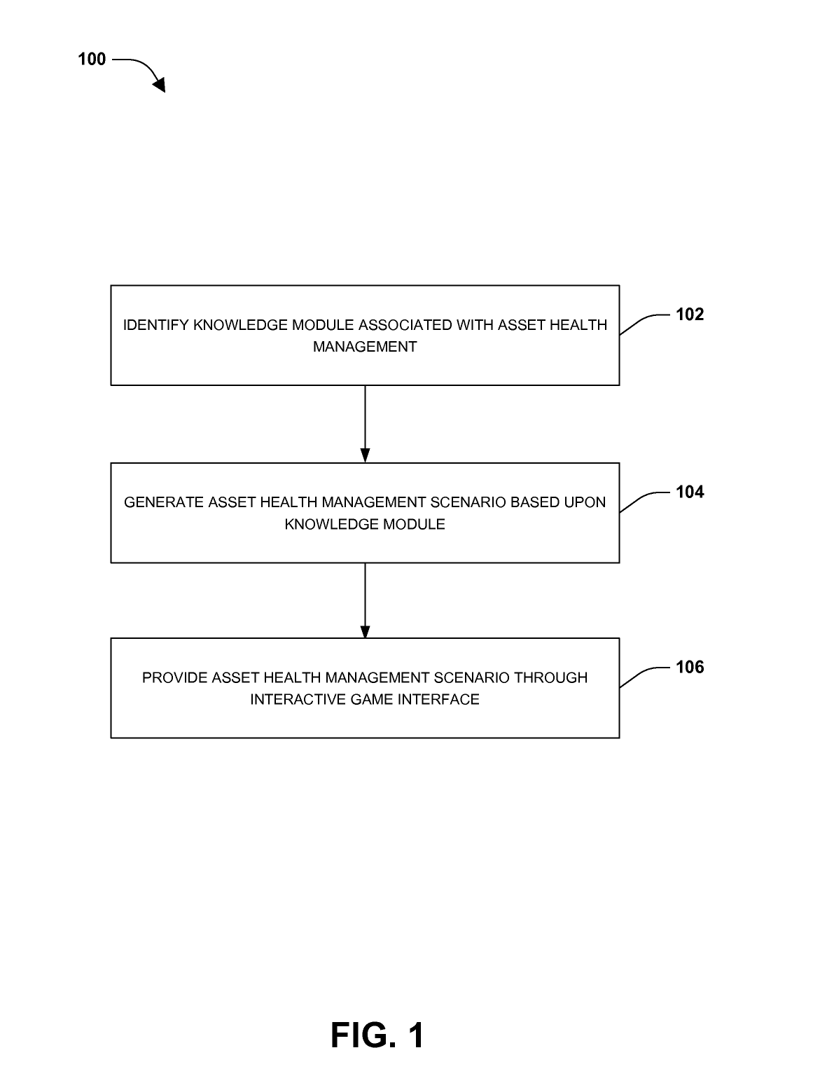

An embodiment of providing an interactive game interface for asset health management is illustrated by an exemplary method 100 of FIG. 1. Various industries, such as electrical utilities, mining, water, and/or a wide variety of other industries, may implement a health asset management system used to diagnose health conditions of assets, create maintenance recommendations for assets, identify criticalities of implementing action plans for assets, and/or perform various tasks associating with managing assets (e.g., managing electrical utility assets such as transformers, transmission lines, circuit breakers, and/or equipment). One or more knowledge modules may be associated with the health asset management system (e.g., a knowledge module comprising health diagnosis algorithms, historical diagnosis data, operating condition trends, statistical data, diagnosis decision making functionality, and/or other information and/or logic related to diagnosis, profiling, and/or prognosis of a health condition of an asset and/or actions to address performance of the asset). Accordingly, a knowledge module associated with asset heath management may be identified, at 102. Because the knowledge module may be updated over time, relatively up-to-date information may be identified from the knowledge module for providing the interactive game interface (e.g., the interactive game interface may evolve over time based upon updates to the knowledge module). In an example, a health diagnosis module (e.g., information regarding how to diagnose and/or predict a condition of an asset), a maintenance module (e.g., various actions that may be implemented for an asset, such as a repair action, a refurbish action, a take offline action, a continue operation action, etc.), an action plan module (e.g., selecting diagnosis, operation, repair, and/or replacement actions, and formulating an action plan, such as by specifying an ordering of actions to perform and/or specifying timing for performance of such actions, which may be evaluated for consequences and/or results), a criticality module (e.g., information regarding potential consequences of an action plan, such as ability/inability to service a client, economic costs, downtime, effect upon a second asset used to compensate for an asset taken offline, an environmental impact, etc.), a decision evaluation module (e.g., information regarding a breakage rate, a diagnosis cause confidence, an action plan confidence, and/or other information related to evaluating and/or ranking actions taken by a user), and/or other modules may be derived from the knowledge module for generation of an asset health management scenario.

At 104, an asset health management scenario may be generated based upon the knowledge module. The asset health management scenario may be generated as an interactive game where a user may be provided with various scenario information relating to an asset (e.g., a visualization of an industrial asset environment comprising the asset; a report detailing a bystander seeing smoke from the asset or other information that may provide contextual information for the scenario; various diagnosis plans that the user may implement (e.g., a diagnosis plan may correspond to at least one of a diagnosis step, a prognosis prediction, or an asset profile); action plans that the user may selective implement; consequences that may be provided for an action plan implemented by the user; and/or other interactive game information such as rewards, rankings, or other information). In an example, an asset type of the asset may be identified (e.g., a manufacturer and/or model information for an asset used by an industry company that employs the user or that uses the user as a contractor). The asset health management scenario may be generated based upon the asset type. In this way, the asset health management scenario may be tailored to assets employed by a particular industry company. In an example, an operating condition of the asset may be identified (e.g., a temperature associated with a location of the asset; a load supplied to a customer of the asset; available equipment owned by the industry company; an operating budget of the industry company; etc.). The asset health management scenario may be generated based upon the operating condition (e.g., configuration information, connectivity information, environmental information, health information, etc.). In another example, the asset health management scenario may be tailored based upon a particular industry, a particular region, a particular company, a particular time of year, etc. (e.g., the asset health management scenario may be tailored according to a first configuration for a power utility in California, may be tailored according to a second configuration for a power utility in Finland, even though both power utilities may utilize similar assets, such as transformers, circuit breakers, generators, etc.). In this way, the asset health management scenario may be tailored to the characteristics of the assets employed by a particular industry company. In an example, a role of a user may be identified (e.g., a short-term planner, a long-term planner, an employee, the general public, a control center user, a field crew user, management, an executive, a financial officer, a regulator, etc. The asset health management scenario may be generated based upon the role. In another example, the asset health management scenario may also be tailored according to the individual user (e.g. background, experience, game ranking, etc.). In this way, the asset health management scenario may be tailored to the user. In an example, a previous action plan selected by the user and/or a previous consequence provided to the user based upon a previous asset health management scenario performed by the user may be identified (e.g., the user may have selected to allow a transformer to continue operation in a degraded state). In another example, the asset health management scenario may be generated based upon the previous consequence (e.g., the asset health management scenario may provide a scenario where the transformer explodes or fails due to the prior action plan).

At 106, the asset health management scenario may be provided through the interactive game interface to the user for interactive gameplay. In an example, the interactive game interface may be provided through a website, a mobile app accessible to a mobile device (e.g., a tablet, a mobile phone), operating equipment, and/or a variety of other computing devices and/or interfaces (e.g., a virtual reality environment, a touchless 3D environment, etc.). In this way, the user may participate in (e.g., “play”) the asset health management scenario through the interactive game interface. In an example, the user may have the option of collaborating with one or more other users in order to collaboratively participate in the asset health management scenario. For example, a user may collaborate with other named players known to the user, the user may consult other available players registered within a game environment hosting interactive game interfaces, and/or the user may be assigned to a crew having a mixture of human and/or game-generated crewmates. In an example, a diagnosis interface may be presented through the interactive game interface. For example, instructions, a visualization of an industrial asset environment for inspection, and/or various contextual information about the scenario may be provided (e.g., an alarm raised for an asset; a bystander report about a lightning strike to the asset; an outage report; an inspection reminder; etc.) may be provided through the diagnosis interface. The diagnosis interface may be populated with one or more diagnosis plans for selection by the user (e.g., utilize budget money or request a budget increase in order to send out an inspection crew; initiate remote diagnosis functionality; view environment laws; send an email question to the bystander; inspect current budget; view condition history for asset; etc.). In an example, the user may specify a user specified diagnosis plan through the diagnosis interface, and in some embodiments the user may specify the order and/or timing of the steps in the plan(s). Responsive to receiving one or more selected diagnosis plans and/or a user specified diagnosis plan, the diagnosis plans may be implemented and/or information related to a result of implementing the diagnosis plan may be provided to the user. In this way, the user may be trained in how to diagnose and/or investigate health conditions of assets.

In an example, an action plan interface may be displayed through the interactive game interface. The action plan interface may be populated with one or more action plans for selection by the user (e.g., schedule maintenance for an asset; send out a repair crew; continuation operation of the asset; replace the asset; increase budget associated with the asset; request a budget increase; etc.). In an example, the user may specify a user specified action plan through the action plan interface. Responsive to receiving a selected action plan and/or a user specified action plan, the action plan may be implemented. In an example, the action plan may be evaluated using information from the knowledge module, such as the criticality module, the action plan module, and/or the decision evaluation module. For example, the action plan may be evaluated based upon criticality information to determine a consequence of the action plan (e.g., the consequence may detail an effect of the action plan upon a budget, an environment impact, a likelihood of damage, a likelihood of injury such as an explosion from continued operation, an effect to a second asset such as an asset used to compensate for an asset taken offline, a temporal aspect as to how the action plan affects a future state of assets or a budget, a cascade effect of an action plan on one or more assets, temporal information corresponding to one or more results of an action plan, etc.). The consequence may be provided through the interactive game interface. In an example, the diagnosis plan, the action plan, and/or the consequence may be evaluated using the decision evaluation module to generate a decision evaluation. The decision evaluation may specify a diagnosis cause confidence as to what caused the problem such as in relation to how the user diagnosed the cause; an action plan confidence such as a score for how the user responded to the asset health management scenario; a breakage rate for the asset based upon the action plan; a suggestion action plan derived from the knowledge module such as an action plan having a desired outcome (e.g., an action plan that mitigates injury, asset damage, budgetary impact, environmental fines, etc.). The decision evaluation may be provided through the interactive game interface. In this way, the user may be trained in how to take action with respect to asset health management based upon the knowledge module.

The user may be ranked based upon completion of the asset health management scenario and/or other asset health management scenarios (e.g., based upon scores provided through decision evaluations). The user may be provided with a reward (e.g., a reward specified by an industrial company that employs the user) based upon completion of the asset health management scenario. In an example, the knowledge module may be modified based upon the user having a game rank above a threshold, which may be indicative of the user being an “expert”. For example, responsive to the user selecting an action plan (e.g., an action plan contrary to an “optimal” action plan answer) and/or providing a user specified action plan (e.g., an action plan not yet addressed by the knowledge module, such as a unique solution to a problem), the knowledge module may be trained based upon such action plans (e.g., the user may possess knowledge and/or take into consideration information not yet comprised within the knowledge module). In this way, knowledge from users may be leveraged to improve the knowledge module for real-life asset health management (e.g., a parameter, an algorithm, and/or other information implemented by a health asset management system for real-time health asset management may be updated).

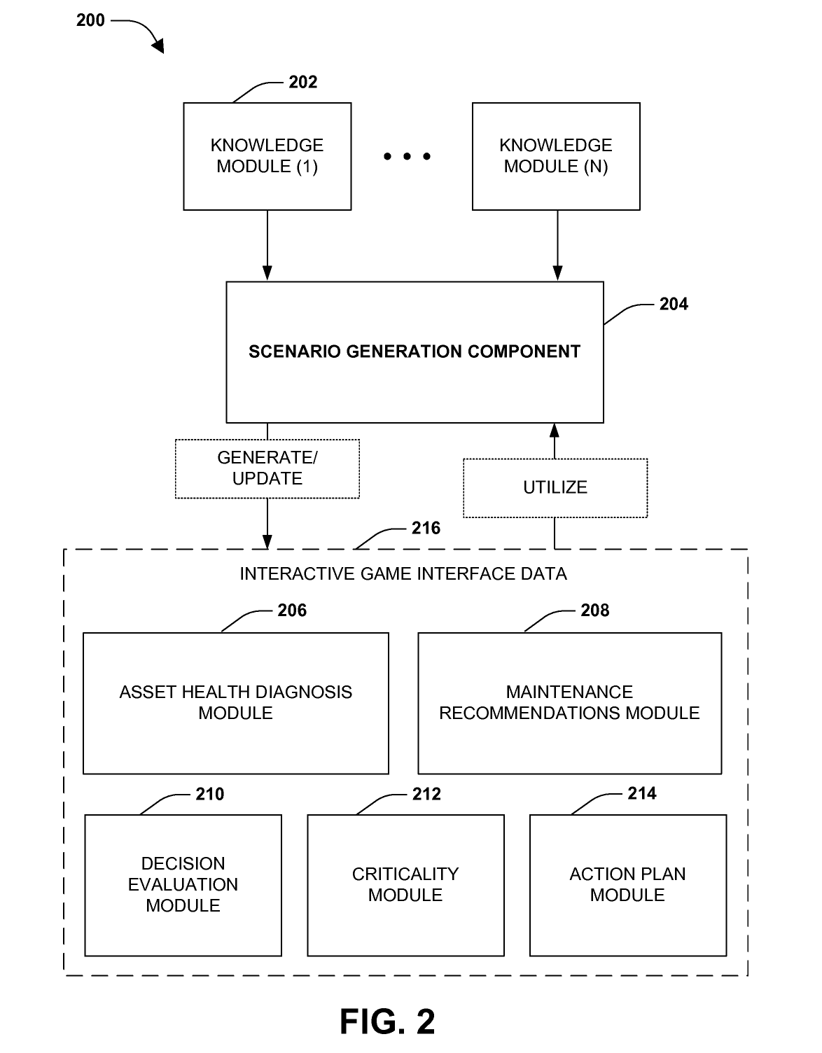

FIG. 2 illustrates an example of a system 200 for identifying one or more knowledge modules. The system 200 may comprise a scenario generation component 204. The scenario generation component 204 may be associated with an asset health management system (e.g., a utility asset management system employed by a utility company to diagnose health conditions of utility assets and/or implement action plans for utility assets). The scenario generation component 204 may identify a knowledge module (1) 202 and/or other knowledge modules associated with the health asset management system. The scenario generation component 204 may utilize the knowledge module (1) 202 to create interactive game interface data 216 used to generate one or more asset health management scenarios for an interactive game interface. For example, the scenario generation component 204 may derive an asset health diagnosis module 206 (e.g., comprising information used to diagnose assets), a maintenance recommendation module 208 (e.g., comprising information used to provide diagnosis or maintenance recommendations for assets), an action plan module 214 (e.g., comprising information used to provide action plan recommendations for assets), a criticality module 212 (e.g., comprising information related to consequences for implementing various action plans), a decision evaluation module 210 (e.g., comprising information used to evaluate and/or score action plans taken by user), and/or a variety of other information.

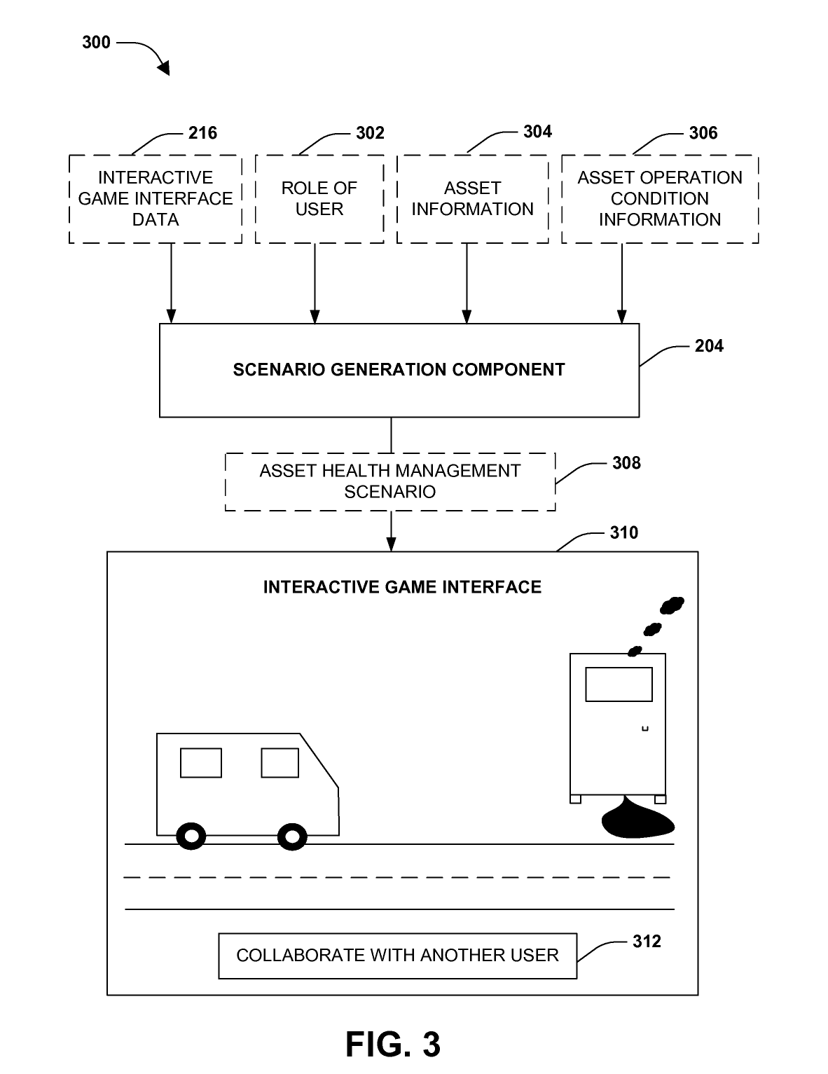

FIG. 3 illustrates an example of a system 300 for providing an interactive game interface 310. The system 300 comprises a scenario generation component 204. In an example, the scenario generation component 204 may have identified a knowledge module 202 associated with asset health management, and may have generated interactive game interface data 216 based upon the knowledge module 202 (e.g., FIG. 2). The scenario generation component 204 may be configure to generated an asset health management scenario 308 based upon the interactive game interface data 216 and/or other information. In an example, a role 302 of a user, such as an electrical utility field crew employee, may be taken into account (e.g., the asset health management scenario 308 may correspond to a transformer asset maintenance decision, as opposed to an executive budgetary decision that would otherwise be generated for a financial officer). The role 302 may correspond to a job responsibility that may be used to create gameplay decisions that may be presented to the user. The role 302 may specify an actual experience (e.g., the user worked on breakers manufactured by a particular company, but not by another company), a targeted experience, and/or a job level (e.g., junior technician vs. crew leader).

In another example, operating industry and/or environmental information may be taken into account, such as domain (e.g., industry), region (e.g., Europe, California, a small country in Africa, etc.), ambient temperature, etc. (e.g., which may be taken into account due to variation between a first electric utility and a second electric utility). Such information may be used to influence an assigned role for the user, how an asset degrades or performs, whether a failure of an asset or segment is likely to “cascade” (e.g., affect other assets), regulatory or other consequences of poor performance, parts availability, lead times, etc.

In another example, a potential for a non-routine scenario may be taken into account. For example, an electric utility that employs the user may be located within a hurricane region. The asset health management scenario 308 may comprise a non-routine scenario, such as aiding in storm relief in unfamiliar operating areas (e.g., the user may be dispatched to a storm damaged area within the user's employer's region, or may be dispatched to an area outside the employer's region to assist in restoration after a major event). In this way, the user may be trained for various scenarios beyond merely routine daily activities.

In another example, asset information 304 may be taken into account (e.g., an asset model, an asset manufacturer, an asset age, and/or other information associated with assets of an electrical utility company that employs the user). In another example, asset operation condition information 306 may be taken into account (e.g., a temperature of a location at which the electrical utility company has deployed the asset; type of industrial operation such as power transmission utility vs. data center vs. coal mining; resources available to an electrical utility company such as distance to a fire station; whether the asset is located near a potential natural disaster area such as a location susceptible to hurricanes; environmental laws; etc.). In this way, the scenario generation component 204 may generate the asset health management scenario 308. The scenario generation component 204 may provide the asset health management scenario 308 through the interactive game interface 310 to the user for interactive gameplay. For example, a visualization of an industrial asset environment for inspection by the user may be provided (e.g., the transformer asset may have smoke and/or liquid leaking from the transformer asset). The user may invoke collaboration functionality 312 in order to collaborate with one or more other users (e.g., a human user, a computer generated teammate, an assignment to a crew of users) to participate in the asset health management scenario 308. In an example, the user may participate in a crew that may interact with other crews during gameplay (e.g., a second crew may have equipment that the user may need, such that the user may ask the second crew for the equipment or may return to a base office to fetch the equipment). In this way, a collaborative interactive gameplay environment may be facilitated (e.g., similar to a massive multiplayer online (MMO) type environment).

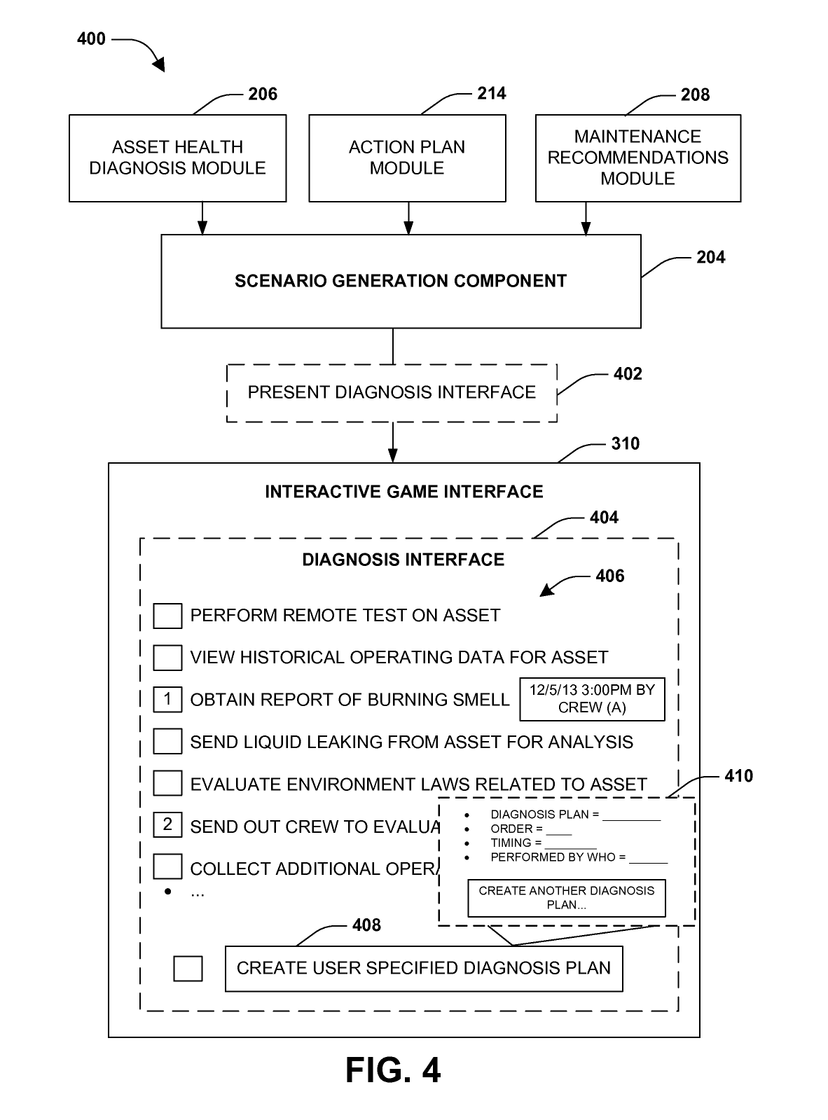

FIG. 4 illustrates an example of a system 400 for presenting 402 a diagnosis interface 404 through an interactive game interface 310. The system 400 comprises a scenario generation component 204 and/or interactive game interface data 216 (e.g., an asset health diagnosis module 206, a maintenance recommendations module 208, an action plan module 214, etc.). In an example, the scenario generation component 204 may have provided an asset health management scenario 308 through the interactive game interface 310 (e.g., FIG. 3). The scenario generation component 204 may be configured to provide the diagnosis interface 404 through the interactive game interface 310 for the asset health management scenario 308. The diagnosis interface 404 may be populated with zero or more diagnosis plans 406 for selection by a user, such as a perform remote test diagnosis plan, a view historical operating data diagnosis plan, an obtain report diagnosis plan, a send liquid for analysis diagnosis plan, an evaluate environment laws diagnosis plan, a send out inspection crew diagnosis plan, a collect additional operating conditions diagnosis plan, and/or a variety of other diagnosis plans. In an example, zero diagnosis plans may be provided, such as when the user is playing under a relatively harder gameplay mode, so that the user is to create diagnosis plans. In another example, the user may select one or more diagnosis plans 406, which may be interleaved with one or more user specified diagnosis plans. The user may select zero or more diagnosis plans 406 (e.g., the user may select a single diagnosis plan, select multiple diagnosis plans, and/or specify a user specified diagnosis plan) or may choose not to perform any diagnostic activities.

In an example, the user may optionally invoke create user specified diagnosis plan functionality 408 through which the user may optionally specify a user specified diagnosis plan (e.g., a diagnosis creation interface 410 may be provided through which the user may specify the user created diagnosis plan, an ordering, timing, who is to perform the user created diagnosis plan, and/or the ability to create additional diagnosis plans). In an example, the user may specify an ordering (e.g., where multiple diagnosis steps are specified), timing for one or more diagnosis steps, work assignments (e.g., what organization, person, role, etc. are to perform one or more diagnosis steps), etc. For example, the user may create a user specified diagnosis plan to retrieve a voltmeter from a utility shed. The user may select a measure voltage diagnosis plan from the one or more diagnosis plans 406 to perform after retrieving the voltmeter. The user may select a obtain supervisor opinion from the one or more diagnosis plans 406 to perform after measuring the voltage. In this way, the user may select and/or specify various steps to take in a particular ordering (e.g., the order may be selected by a drag-and-drop command, by the user assigning a numerical order, by voice command, etc.) and/or timing (e.g., an absolute timing or a relative time interval with respect to “now” in the game or with respect to a time of a previous diagnosis step). For example, the user may select to first obtain a report of a burning smell (e.g., send out crew (a) at 3:00 on Dec. 5, 2013 to obtain the report), and then send out a crew to evaluate health of the asset, and finally the user may create a user specified diagnosis plan to view historical operating conditions of the asset. In an example, the user may skip diagnosis, and may select an action to perform (e.g., repair, reduce usage, run to failure, etc.).

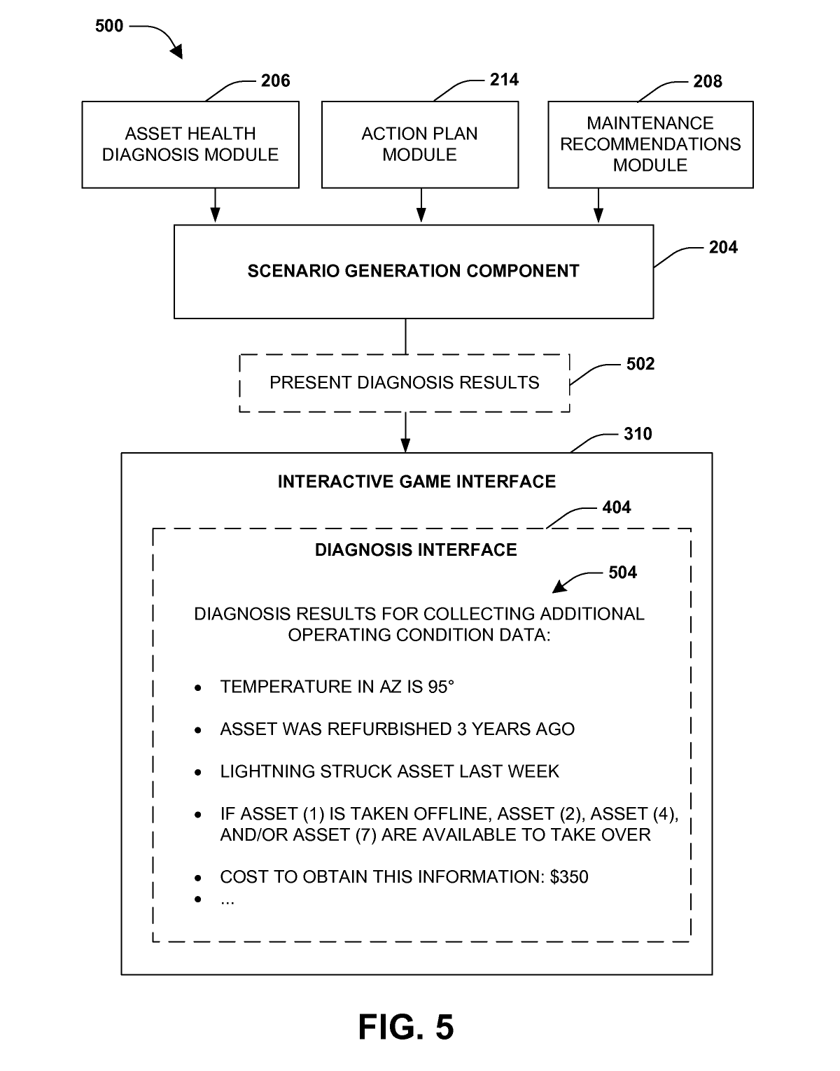

FIG. 5 illustrates an example of a system 500 for presenting 502 diagnosis results 504 through a diagnosis interface 404 provided through an interactive game interface 310. The system 500 comprises a scenario generation component 204. In an example, the scenario generation component 204 may have provided the diagnosis interface 404, associated with an asset health management scenario 308, through the interactive game interface 310 (e.g., FIG. 4). The scenario generation component 204 may have received a selection of a diagnosis plan and/or a user specified diagnosis plan through the diagnosis interface 404. Accordingly, the scenario generation component 204 may provide diagnosis results 504 for the diagnosis plan. For example, responsive to a user selecting a collect additional operating conditions diagnosis plan, a set of operating condition data may be provided as the diagnosis results 504, such as an operating temperature, historical refurbishment information, a lightning strike incident, one or more other assets that may take over if asset (1) is brought offline, a cost to obtain the diagnosis results 504, etc.

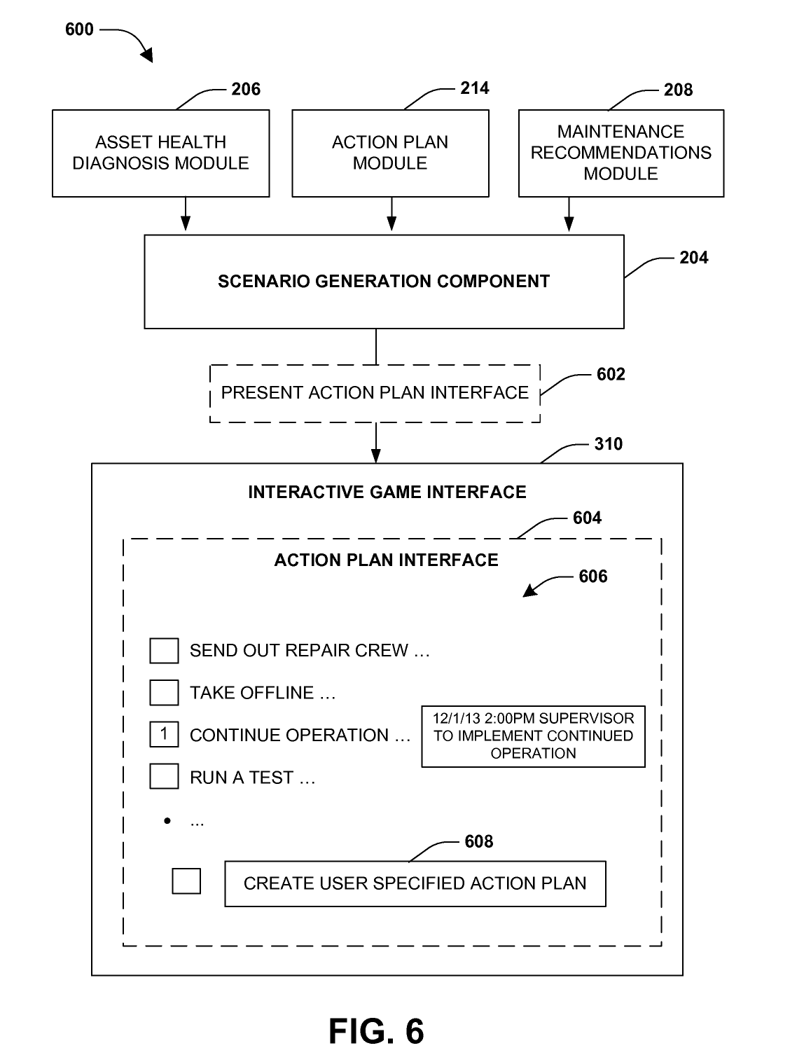

FIG. 6 illustrates an example of a system 600 for presenting 602 an action plan interface 604 through an interactive game interface 310. The system 600 comprises a scenario generation component 204 and/or interactive game interface data 216 (e.g., an asset health diagnosis module 206, a maintenance recommendations module 208, an action plan module 214, etc.). In an example, the scenario generation component 204 may have provided an asset health management scenario 308 through the interactive game interface 310 (e.g., FIG. 3). The scenario generation component 204 may present 602 the action plan interface 604 comprising one or more action plans 606 for selection by a user. For example, a send out repair crew action plan, a take offline action plan, a continue operation action plan, a test action plan (e.g., a further diagnosis option), and/or a variety of other action plans for the asset health management scenario 308 may be populated within the action plan interface 604 for selection by the user. In an example, the user may invoke create user specified action plan functionality 608 through which the user may specify a user specified action plan. In this way, the user may interactively provide an action plan to take in response to the asset health management scenario 308. In an example, available diagnosis options and/or available action options may be provided to the user during any portion of gameplay (e.g., a user may skip diagnosis, and may proceed to perform one or more action plans; a user may perform a first diagnosis and then perform a second diagnosis based upon results from the first diagnosis; a user may select a diagnosis and/or action plan based upon further information becoming available, such as an alarm, a customer call to report an issue, a tweet about a person seeing a fire in a substation, etc.). In an example, the user may select to first run a test as a further diagnosis option, and then the user may select a continuation operation action option (e.g., the user may specifying an order, timing, and/or who is to perform the action, such as a particular supervisor that is to implement continued operation as of Dec. 1, 2013 at 2:00 pm), and finally the user may create the user specified action plan 608 to schedule a re-evaluation of the asset in 3 weeks.

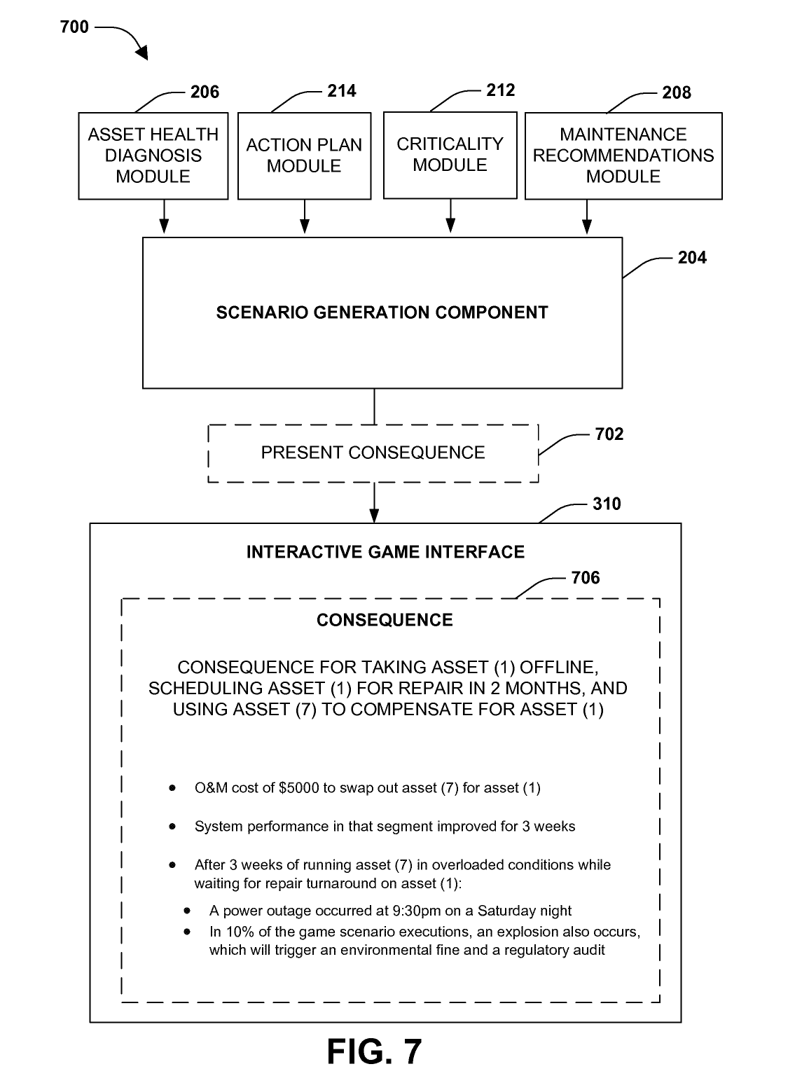

FIG. 7 illustrates an example of a system 700 for presenting 702 a consequence 706 through an interactive game interface 310. The system 700 comprises a scenario generation component 204. In an example, the scenario generation component 204 may have provided an action plan interface 604, populated with one or more action plans 606 that may be selected by a user for an asset health management scenario 308, through the interactive game interface 310 (e.g., FIG. 6). The scenario generation component 204 may evaluate, such as using a criticality module 212, an action plan (e.g., a selected action plan or a user specified action plan) to determine the consequence 706 of the action plan. For example, the action plan may specify that an asset (1) is to be taken offline, scheduled for repair in 2 months, and that an asset (7) is to compensate for asset (1) being taken offline. The consequence 706 may specify an O&M cost of $5,000 to swap asset (7) for asset (1). The consequence 706 may specify that system performance in a segment improved for 3 weeks. The consequence 706 may specify that after 3 weeks of running asset (7) in overloaded conditions while waiting for repair turnaround on asset (1), a power outage occurred at 9:30 on Saturday night and/or that 10% of game scenario executions result in an explosion that triggers an environment fine and a regulatory audit. In an example, a different user (e.g., a dispatcher or control center operator) may be presented with a new scenario (e.g., a decision to reverse the repair of asset (1) in 5 weeks; a decision to call out a night crew at a cost of $1,000; a decision to wait until morning at a cost of $200; etc.). Depending on the decision, the outage cost may be adjusted by the repair crew cost, a cost in lost revenue (e.g., due to not immediately sending out the repair crew), and/or a decrease in the utility's system average interruption duration index (SAIDI). In this way, the user may be provided with training feedback based upon the action plan implemented by the user for the asset health management scenario 308.

In an example, multiple concurrent streams of dynamic changes in scenarios across an enterprise may be facilitated for gameplay. For example, during the 3 week period before the outage occurs, the user (e.g., a crew to which the user is assigned) may handle other incidents (e.g., scenarios). For example, the difficulty and/or number of other incidents (e.g., concurrent incidents) may be set based upon a game setting (e.g., a beginner mode where merely a single subsystem or stream is played out; a journeyman mode where two or three concurrent decision streams or subsystems are played out; an expert mode where a user is to handle concurrent decisions for a relatively large region; etc.). Various game parameters may be used to influence gameplay. In an example, time may be compressed or expanded time for decision making, such as a real-time mode, an untimed mode, or an intermediate mode where the user is credited or penalized for decision making timeliness. In another example, gameplay may show how consequences occur (e.g., a financial planner may jump ahead in time to see consequences such as a month in the future; a surprise may event occur, such as a rate increase request not being approved or a boss requesting an update by the end of the day to reflect an impact of decreased funding for the next 3 years; etc.).

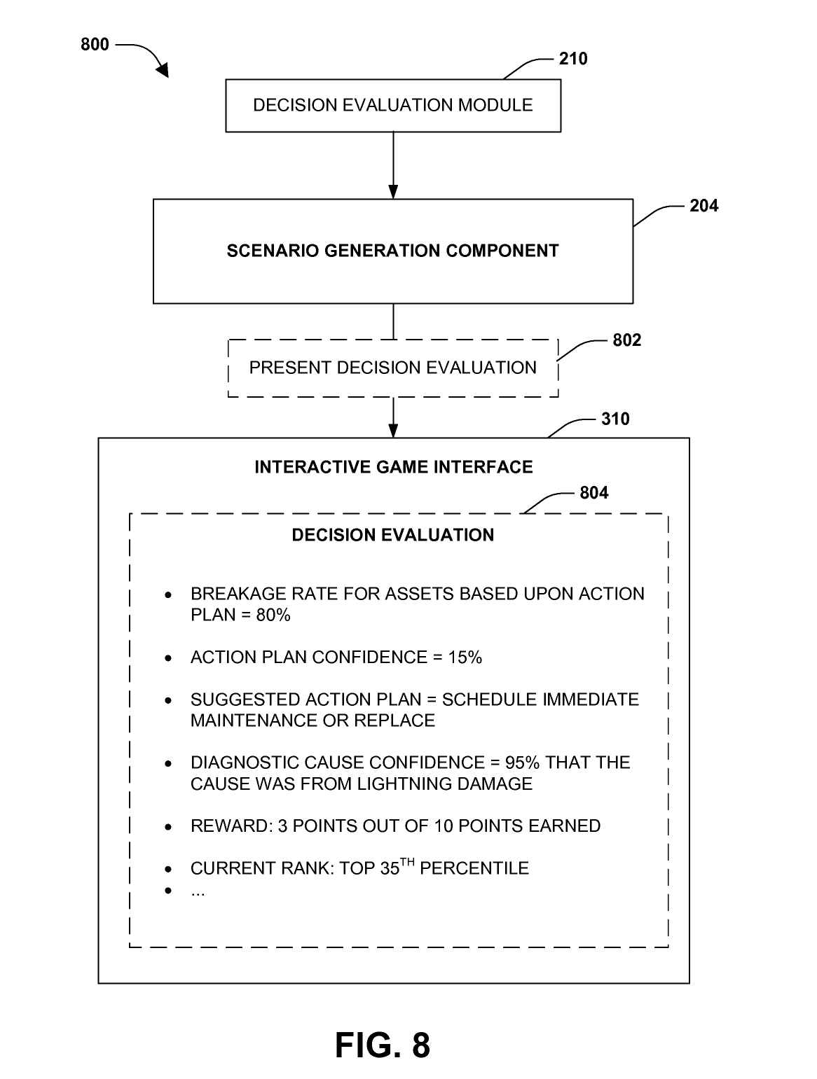

FIG. 8 illustrates an example of a system 800 for presenting 802 a decision evaluation 804 through an interactive game interface 310. The system 800 comprises a scenario generation component 204. In an example, the scenario generation component 204 may have presented 702 a consequence 706 for an action plan implemented for an asset health management scenario 310 provided through the interactive game interface 310 (e.g., FIG. 7). The scenario generation component 204 may evaluate, such as using a decision evaluation module 210, the action plan and/or the consequence 706 to generate the decision evaluation 804. For example, the decision evaluation 804 may provide a breakage rate for assets, such as an asset (1) under evaluation and/or an asset (7) used to compensate for taking asset (1) offline, based upon the action plan. The decision evaluation 804 may provide an action plan confidence, such as a rating as to how confident the scenario generation component 204 is with respect to the action plan, implemented by the user, as being desirable (e.g., whether a knowledge module 202 indicates that the action plan is efficient or desirable). The decision evaluation 804 may provide a suggested action plan (e.g., an answer to the asset health management scenario based upon the knowledge module indicating that the suggestion action plan is efficient or desirable). The decision evaluation 804 may provide a diagnosis cause confidence indicating how confidence the scenario generation component 204 is with respect to a diagnosis identified by the user (e.g., the knowledge module 202 may indicate a 95% confidence that the asset (1) was damaged from lightning as diagnosed by the user). The decision evaluation 804 may provide a reward based upon the diagnosis, action plan, and/or consequence 706, such as a reward of 3 points of out 10 potential points. The decision evaluation 804 may provide a current rank for the user, such as a rank within the top 35^{th} percentile. In this way, various information regarding the user, the action plan, the consequence 706, and/or other information may be provided through the interactive game interface 310.

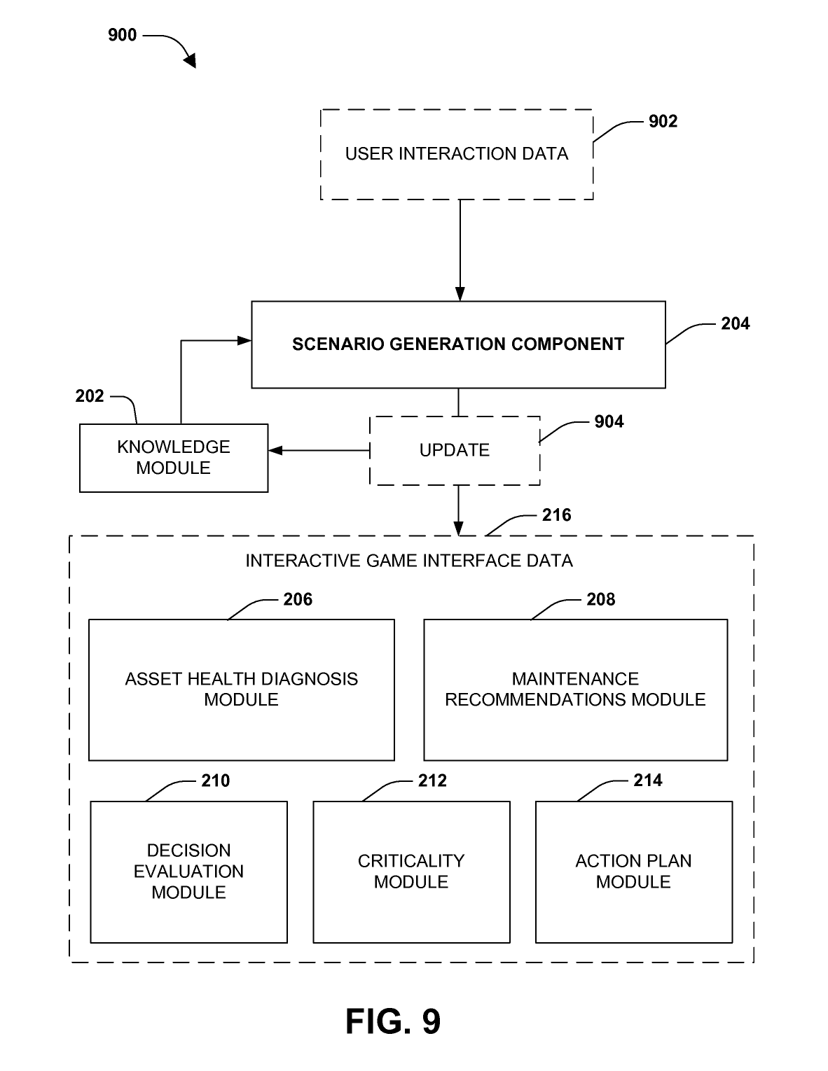

FIG. 9 illustrates an example of a system 900 for modifying a knowledge module 202 and/or interactive game interface data 216 utilizing an update 904 derived from user interaction data 902 associated with an interactive game interface 310. The system 900 comprises a scenario generation component 204. In an example, the scenario generation component 204 may have provided an asset health management scenario 308 through the interactive game interface 310 (e.g., FIG. 3). A user may have provided an action plan to implement for the asset health management scenario 308 (e.g., FIG. 6). The action plan may have been evaluated, and a consequence 706 of the action plan (e.g., FIG. 7) and/or a decision evaluation 804 for the action plan (e.g., FIG. 8) may have been provided as feedback to train the user.

The scenario generation component 204 may be configured to evaluate user interaction data 902 (e.g., a diagnosis plan selected or specified by the user; an action plan selected or specified by the user; and/or a variety of other interactions and/or information provided by the user) in order to generate the update 904. In some embodiments, the update process may involve human review and evaluation. In an example, the update 904 may correspond to an action plan specified by the user, which has a relatively more efficient outcome than a current suggested action plan (e.g., used as an answer by the interactive game interface data 216 and/or used to provide real-time asset health management functionality by the knowledge module 202). In another example, the update 904 may correspond to information and/or patterns not yet addressed by the knowledge module 202 and/or the interactive game interface data 216. In this way, knowledge from the user may be used to create the update 904. The update 904 may be used to modify the knowledge module 202 so that real-time asset health management functionality provided by the knowledge module 202 may be improved. The update 904 may be used to modify the interactive game interface data 216 so that improved answers may be used to train users.

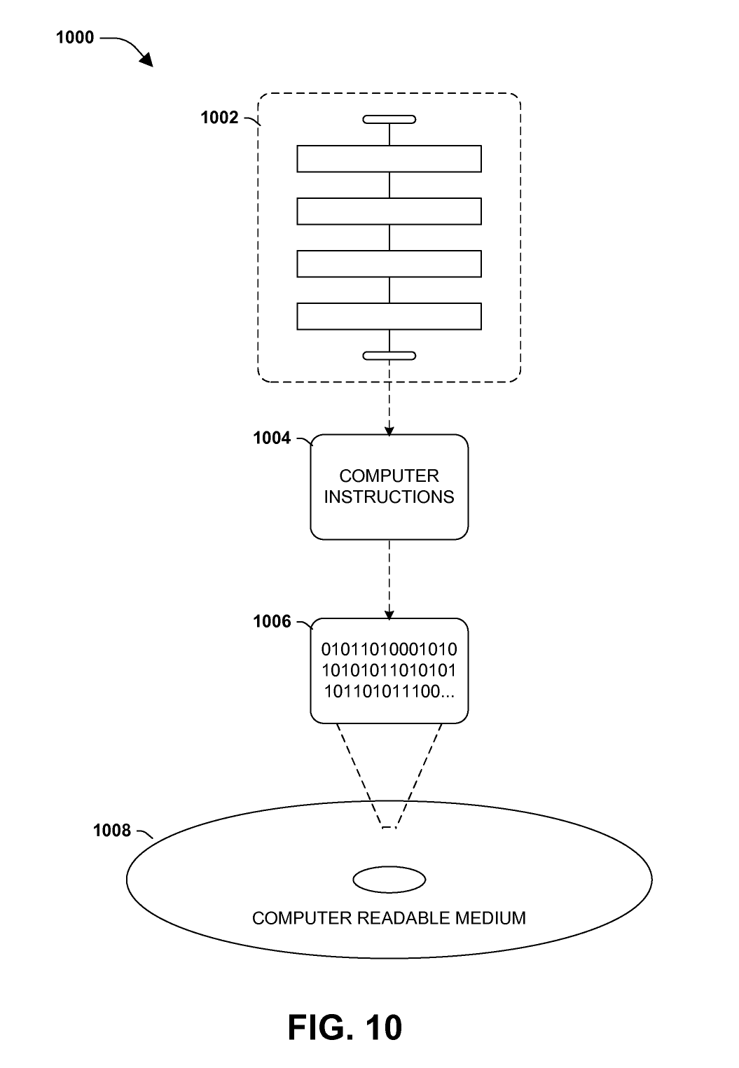

Still another embodiment involves a computer-readable medium comprising processor-executable instructions configured to implement one or more of the techniques presented herein. An example embodiment of a computer-readable medium or a computer-readable device is illustrated in FIG. 10, wherein the implementation 1000 comprises a computer-readable medium 1008, such as a CD-R, DVD-R, flash drive, a platter of a hard disk drive, etc., on which is encoded computer-readable data 1006. This computer-readable data 1006, such as binary data comprising at least one of a zero or a one, in turn comprises a set of computer instructions 1004 configured to operate according to one or more of the principles set forth herein. In some embodiments, the processor-executable computer instructions 1004 are configured to perform a method 1002, such as at least some of the exemplary method 100 of FIG. 1, for example. In some embodiments, the processor-executable instructions 1004 are configured to implement a system, such as at least some of the exemplary system 200 of FIG. 2, at least some of the exemplary system 300 of FIG. 3, at least some of the exemplary system 400 of FIG. 4, at least some of the exemplary system 500 of FIG. 5, at least some of the exemplary system 600 of FIG. 6, at least some of the exemplary system 700 of FIG. 7, at least some of the exemplary system 800 of FIG. 8, and/or at least some of the exemplary system 900 of FIG. 9, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

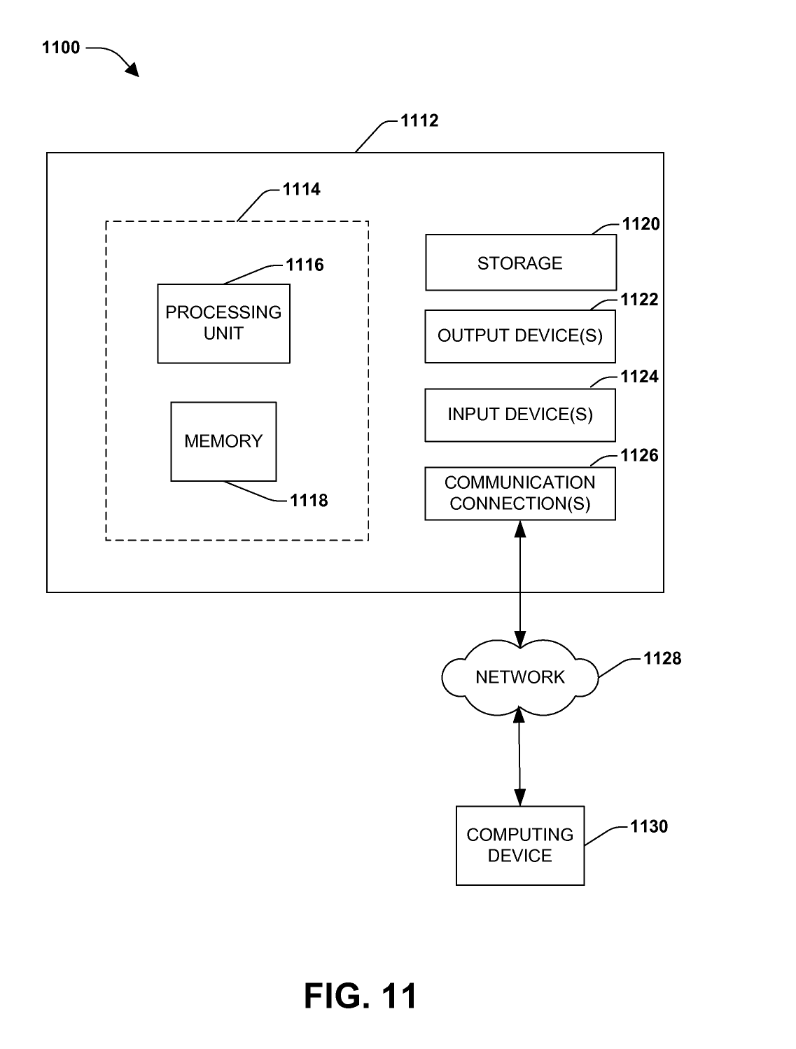

FIG. 11 and the following discussion provide a brief, general description of a suitable computing environment to implement embodiments of one or more of the provisions set forth herein. The operating environment of FIG. 11 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 11 illustrates an example of a system 1100 comprising a computing device 1112 configured to implement one or more embodiments provided herein. In one configuration, computing device 1112 includes at least one processing unit 1116 and memory 1118. Depending on the exact configuration and type of computing device, memory 1118 may be volatile (such as RAM, for example), non-volatile (such as ROM, flash memory, etc., for example) or some combination of the two. This configuration is illustrated in FIG. 11 by dashed line 1114.

In other embodiments, device 1112 may include additional features and/or functionality. For example, device 1112 may also include additional storage (e.g., removable and/or non-removable) including, but not limited to, magnetic storage, optical storage, and the like. Such additional storage is illustrated in FIG. 11 by storage 1120. In one embodiment, computer readable instructions to implement one or more embodiments provided herein may be in storage 1120. Storage 1120 may also store other computer readable instructions to implement an operating system, an application program, and the like. Computer readable instructions may be loaded in memory 1118 for execution by processing unit 1116, for example.

The term “computer readable media” as used herein includes computer storage media. Computer storage media includes volatile and nonvolatile, removable and non-removable media implemented in any method or technology for storage of information such as computer readable instructions or other data. Memory 1118 and storage 1120 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1112. Any such computer storage media may be part of device 1112.

Device 1112 may also include communication connection(s) 1126 that allows device 1112 to communicate with other devices. Communication connection(s) 1126 may include, but is not limited to, a modem, a Network Interface Card (NIC), an integrated network interface, a radio frequency transmitter/receiver, an infrared port, a USB connection, or other interfaces for connecting computing device 1112 to other computing devices. Communication connection(s) 1126 may include a wired connection or a wireless connection. Communication connection(s) 1126 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1112 may include input device(s) 1124 such as keyboard, mouse, pen, voice input device, touch input device, infrared cameras, video input devices, and/or any other input device. Output device(s) 1122 such as one or more displays, speakers, printers, and/or any other output device may also be included in device 1112. Input device(s) 1124 and output device(s) 1122 may be connected to device 1112 via a wired connection, wireless connection, or any combination thereof. In one embodiment, an input device or an output device from another computing device may be used as input device(s) 1124 or output device(s) 1122 for computing device 1112.

Components of computing device 1112 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1112 may be interconnected by a network. For example, memory 1118 may be comprised of multiple physical memory units located in different physical locations interconnected by a network.

Those skilled in the art will realize that storage devices utilized to store computer readable instructions may be distributed across a network. For example, a computing device 1130 accessible via a network 1128 may store computer readable instructions to implement one or more embodiments provided herein. Computing device 1112 may access computing device 1130 and download a part or all of the computer readable instructions for execution. Alternatively, computing device 1112 may download pieces of the computer readable instructions, as needed, or some instructions may be executed at computing device 1112 and some at computing device 1130.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for providing an interactive interface for asset health management, comprising:
identifying a knowledge module associated with asset heath management;
generating an asset health management scenario based upon the knowledge module; and
providing the asset health management scenario through an interactive interface to a user for interactive play.

2. The method of claim 1, the identifying a knowledge module comprising:
evaluating the knowledge module to derive at least one of a health diagnosis module, a maintenance recommendations module, an action plan module, a criticality module, or a decision evaluation module for generation of the asset health management scenario.

3. The method of claim 1, the providing the asset health management scenario comprising:
displaying a visualization of an industrial asset environment for inspection by the user; and
receiving a diagnosis plan from the user, the diagnosis plan corresponding to at least one of a diagnosis step, a prognosis prediction, or an asset profile.

4. The method of claim 1, the providing the asset health management scenario comprising:
presenting a diagnosis interface through the interactive interface; and
populating the diagnosis interface with one or more diagnosis plans for selection by the user.

5. The method of claim 1, the providing the asset health management scenario comprising:
presenting a diagnosis interface through the interactive interface; and
receiving at least one of one or more user specified diagnosis plans, one or more selected diagnosis plans, a diagnosis plan ordering, or diagnosis plan timing through the diagnosis interface.

6. The method of claim 1, the providing the asset health management scenario comprising:
displaying an action plan interface through the interactive interface; and
populating the action plan interface with one or more action plans for selection by the user.

7. The method of claim 1, the providing the asset health management scenario comprising:
displaying an action plan interface through the interactive interface; and
receiving at least one of one or more user specified action plans, one or more selected action plans, an action plan ordering, or an action plan timing through the action plan interface.

8. The method of claim 1, comprising:
receiving an action plan from the user;
evaluating the action plan based upon criticality information from the knowledge module to determine a consequence of the action plan; and
providing the consequence through the interactive interface.

9. The method of claim 8, the criticality information corresponding to at least one of an effect upon a second asset based upon implementation of the action plan on a first asset, a cascade effect of the action plan on one or more assets, or temporal information corresponding to one or more results of the action plan.

10. The method 8, comprising:
evaluating at least one of the action plan or the consequence using a decision evaluation module to generate a decision evaluation; and
providing the decision evaluation through the interactive interface.

11. The method of claim 10, the decision evaluation specifying at least one of a breakage rate, a diagnosis cause confidence, an action plan confidence, a consequence confidence, or a suggested action plan.

12. The method of claim 8, the consequence comprising a temporal aspect corresponding to how the action plan affects a future state of one or more assets.

13. The method of claim 8, comprising:
responsive to determining that the user has a rank above a threshold, modifying the knowledge module based upon the action plan.

14. The method of claim 1, the generating an asset health management scenario comprising:
identifying an operating condition of an asset, the operating condition corresponding to at least one of configuration information, connectivity information, environmental information, or health information; and
generating the asset health management scenario based upon the operating condition.

15. The method of claim 1, the generating an asset health management scenario comprising:
identifying an asset type of an asset; and
generating the asset health management scenario based upon the asset type.

16. The method of claim 1, the generating an asset health management scenario comprising:
identifying a role of the user; and
generating the asset health management scenario based upon the role.

17. The method of claim 1, the generating an asset health management scenario comprising:
identifying a previous consequence provided to the user based upon a previous asset health management scenario; and
generating the asset health management scenario based upon the previous consequence.

18. The method of claim 1, comprising:
modifying at least one of the knowledge module or the asset health management scenario based upon user interaction with the asset health management scenario.

19. The method of claim 1, comprising:
facilitating collaboration between the user and a second user through the asset health management scenario.

20. The method of claim 1, comprising at least one of:
ranking the user based upon completion of the asset health management scenario; or
providing a reward to the user based upon completion of the asset health management scenario.

21. A system for providing an interactive interface for asset health management, comprising:
a scenario generation component configured to:
identify a knowledge module associated with asset heath management;
generate an asset health management scenario based upon the knowledge module; and
provide the asset health management scenario through an interactive interface to a user for interactive play.

22. The system of claim 21, the scenario generation component configured to:
receive an action plan from the user;
evaluate the action plan based upon criticality information from the knowledge module to determine a consequence of the action plan; and
provide the consequence through the interactive interface.

23. The system of claim 21, the scenario generation component configured to:
modify at least one of the knowledge module or the asset health management scenario based upon user interaction with the asset health management scenario.

24. A computer readable medium comprising instructions that when executed perform a method for providing an interactive interface for asset health management, comprising:
identifying a knowledge module associated with asset heath management;
generating an asset health management scenario based upon the knowledge module; and
providing the asset health management scenario through an interactive interface to a user for interactive play.
